(19) United States
(12) Patent Application Publication
(10) Pub. No.: US 2005/0081898 A1
(43) Pub. Date: Apr. 21, 2005

(54) All purpose cleaning machine

(76) Inventors: Steve Williams, Hayden Lake, ID (US); Mark Havel, Willamina, OR (US)

Correspondence Address: Alan D. Kamrath;Rider Bennett, LLP, Suite 2000, 333 South Seventh Street, Minneapolis, MN, 55402, US

(21) Appl. No.: 10/686,784

(22) Filed: Oct. 15, 2003

(51) Int. Cl. B08B 3/02

(52) U.S. Cl. 134/172; 134/201

(57) ABSTRACT

An all purpose cleaning machine (10) includes a recovery tank (40) pivotable relative to a base assembly (12) and a solution tank (26) between an access position and a transport position. Hose reels (56, 58) are slidably received by movement in a radial direction inside the semicylindrical portion (72) of a J-shaped depression (70) for rotation therein. Hose reels (56, 58) hold hoses (62, 64) and are removable when it is desired to move the recovery tank (40) from its transport position to its access position by simply lifting them from the depression (70). In the transport position, tool channels (34, 48) are defined in the front (30) of the solution tank (26) and the back (46) of the recovery tank (40) for slideably receiving tools for support on the bottom faces of the tool channels (34, 38).

### BACKGROUND

The present invention generally relates to an all purpose cleaning machine and specifically to all purpose cleaning machines which are of compact size and easy to maneuver.

Cleaning machines adapted to clean a variety of surfaces such as found in bathrooms, locker rooms, swimming pools, and the like have gained in popularity. Due to the variety of surfaces desired to be cleaned and to the variety of cleaning operations desired to be performed when cleaning such surfaces, solution hoses and vacuum hoses as well as possibly blowing hoses and electric cords are provided. On currently marketed all purpose cleaning machines, the hoses are wrapped on the exterior of the machine such as around hose wraps or protrusions on the machine such as handle portions. Such wrapped hoses are unsightly and can become easily tangled. Additionally, when it is necessary to access the mechanical components of the machine such as for servicing including but not limited to changing filters and the like, it is often necessary to unwrap the hoses to allow the machine to be moved to an access condition and then to again wrap the hoses to the machine after servicing has been finished.

In addition to hoses, all purpose cleaning machines transport cleaning accessories such as vacuum wands, scrub brushes, spray guns, nozzles, squeegees and the like utilized during the cleaning operations. Such accessories were often releasably fastened or simply laid on the exterior surface of currently marketed all purpose cleaning machines. Similarly, gallon bottles containing disinfectant and other cleaning solutions are desired and often are just set down on exterior surfaces of currently marketed all purpose cleaning machines. Such accessories and gallon bottles provide an unsightly appearance, are prone to falling from the machine during transport, and are otherwise operationally undesirable.

Thus, a need exists for all purpose cleaning machines which overcome the deficiencies of prior cleaning machines. Specifically, cleaning machines should store each of the hoses, cleaning accessories, and cleaning solution supplies, while reducing overall size. The hoses should be stored in a manner which eliminates tangle hassles and allows removal and replacement from the machine without the need for unwrapping or wrapping the hose. The reduced size should allow the machine to be stored in reduced space, to be easily maneuvered, and to provide good sight lines during transport.

### SUMMARY

The present invention solves these needs and other problems in the field of surface cleaning by providing in the preferred form, a depression of a size and shape to slideably receive discs of a hose reel upon which a hose can be wound. The hose reel slideably received inside of the depression is rotatable about the center spool of the hose reel. In a first aspect of the present invention, the depression is formed in a tank for solution utilized in the cleaning operations. In other aspects of the present invention, the hose reel is slideably received in the depression by movement of the hose reel in a radial direction to the center spool of the hose reel. For most preferred forms, the hose reel is rotatably mounted by engaging the outer peripheries of first and second discs with the depression.

In another aspect of the present invention, a tank is moveable relative to an L-shape support structure between a transport position and an access position. In the transport position, a bottom of the tank engages with a top of a horizontal portion of the L-shaped support structure and the back of the tank engages with a front of a vertical portion of the L-shaped support structure, and, in the access position, they are at least partially spaced. A tool channel is integrally formed in one or both of the back of the tank and the front of the vertical portion and is adapted to slideably receive tools for support on the bottom face of the tool channel when the tank is in the transport position.

Thus, it is a desire of the present invention to provide a novel all purpose cleaning machine.

It is further a desire of the present invention to provide such a novel all purpose cleaning machine which may store hoses on reels to eliminate tangle hassles and reduce storage space and in the most preferred aspects can be easily removed and replaced without unwrapping the hose and without the use of tools and does not require a center shaft.

It is further a desire of the present invention to provide such a novel all purpose cleaning machine which may include a tool channel for storing cleaning accessories spaced from the exterior surface of the machine and which allows removal and replacement of the cleaning accessories without the use of tools.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a perspective view of an all purpose cleaning machine in a transport position according to the preferred teachings of the present invention.

FIG. 2 shows a perspective view of the all purpose cleaning machine of FIG. 1 in an access position, with the hose reels being removed.

All figures are drawn for ease of explanation of the basic teachings of the present invention only; the extensions of the figures with respect to number, position, relationship, and dimensions of the parts to form the preferred embodiment will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in the various figures of the drawings, the same numerals designate the same or similar parts. Furthermore, when the terms “top”, “bottom”, “first”, “second”, “front”, “back”, “outer”, “inner”, “upper”, “lower”, “height”, “width”, “length”, “size”, “end”, “side”, “horizontal”, “vertical”, “axial”, “radial”, and similar terms are used herein, it should be understood that these terms have reference only to the structure shown in the drawings as it would appear to a person viewing the drawings and are utilized only to facilitate describing the illustrative embodiment.

### DESCRIPTION OF AN ILLUSTRATIVE EMBODIMENT

An all purpose cleaning machine according to the preferred teachings of the present invention is shown in the drawings and generally designated 10. Generally, machine 10 includes a base assembly 12 which is moveably supported upon a floor surface such as by wheels 14 mounted on the opposite ends of an axle extending through assembly 12 at the rear thereof and by casters 16 mounted on opposite sides of assembly 12 at the front thereof. In the most preferred form, assembly 12 is a tipped h-shape including a projecting portion 18 extending from an enlarged portion 20. At least enlarged portion 20 is hollow for receiving the mechanical components such as but not limited to a solution pump and plumbing associated therewith and a vacuum/blower unit and plumbing associated therewith. The mechanical components are conventional, with the type depending upon the particular cleaning operations desired. In the most preferred form, the enlarged portion 20 of assembly 12 has an open top. In a preferred form, hinge tabs 22 are integrally formed in the upper front corner of enlarged portion 20 of assembly 12. The axle of wheels 14 of the preferred form extends through and is supported by projecting portion 18.

Machine 10 further includes, in the preferred form shown, a solution tank 26 of a generally hollow parallelepiped shape. Specifically, solution tank 26 includes a bottom, a top panel 28, a front 30, a back, and sides. In the most preferred form, the bottom of tank 26 engages and is supported upon projecting portion 18, with the length of tank 26 between front 30 and the back being generally equal to the extent that portion 18 projects from portion 20. Front 30 engages and abuts with the back of portion 20, with the height of tank 26 between top panel 28 and the bottom being substantially greater than the height of portion 20. In the preferred form shown, the bottom and sides of tank 26 include a recess for receipt of and clearance for wheels 14.

For purposes of moving machine 10, a handle 32 can be provided attached to solution tank 26 in the preferred form shown. In the most preferred form, handle 32 is generally U-shaped and has its free ends adjustably pivotably mounted in recesses in the back of solution tank 26. It can be appreciated that the mounting of handle 32 including but not limited to adjustably pivotably mounting can be performed by any suitable manner and can be at a variety of locations on machine 10 as will be known by a person skilled in the art. Likewise, handle 32 can be of a variety of forms and/or types as will be known by a person skilled in the art. In fact, when applied to machines 10 intended to be ridden by the operator, handle 32 could be omitted and replaced at least partially by a steering mechanism.

In the most preferred form of the present invention, front 30 includes first and second tool channels or troughs 34 extending from top panel 28 to a lower extent equal to or above enlarged portion 20. Troughs 34 are integrally formed with front 30 and include a back face which is spaced from the plane of front 30, side faces which extend from the back face to front 30, and a bottom face extending between front 30 and the bottom ends of the back and side faces.

Additionally, in the most preferred form of the present invention, top panel 28 includes first and second bottle wells or depressions 36 extending to a lower extent equal to about one-fourth of the height of a conventional gallon bottle. Specifically, depressions 36 each include a side face of a generally cylindrical configuration of cross sections preferably to accommodate bottles of different cross sections including but not limited to circular, square, and rectangular. The side face terminates in a bottom face. Depression 36 is of a size and shape to slideably receive the lower portion of a conventional gallon bottle.

Machine 10 further includes in the preferred form shown a recovery tank 40 including a bottom adapted to engage and be supported upon the top of enlarged portion 20. In the most preferred form, hinge tabs 42 are integrally formed in the lower front corner of tank 40 between the bottom and a front 44. Suitable hinge pins extend between hinge tabs 22 and 42 to pivotably mount tank 40 relative to assembly 12 between a transport position with tank 40 engaging enlarged portion 20 and closing the open top thereof and an access position with tank 40 not closing the open top and allowing access to the hollow interior of assembly 12.

In the form shown, tank 40 includes a back 46 which engages with front 30 of tank 26 when tank 40 is in the transport position and in the most preferred form is generally perpendicular to the bottom and parallel to but spaced from front 44. According to the preferred teachings of the present invention, back 46 includes first and second tool channels 48 of a size, shape, and location corresponding to tool channels 34 of tank 26. Channels 48 are integrally formed with back 46 and include a front face which is spaced from the plane of back 46, side faces which extend from the front face to back 46 and a bottom face extending between back 46 and the bottom ends of the front and side faces.

It should be appreciated that base assembly 12 and solution tank 26 define a support structure for recovery tank 40, with assembly 12 and tanks 26 and 40 generally defining the body of machine 10. The support structure defined by assembly 12 and solution tank 26 is movably supported upon the surface in the preferred form by wheels 14 and casters 16 and is generally L-shaped. The horizontal portion of the L-shape is defined by enlarged portion 20, while the vertical portion of the L-shape is defined by projecting portion 18 and tank 26 in the preferred form shown. The top of enlarged portion 20 intersects with front 30 of tank 26 and in the most preferred form generally perpendicularly.

Additionally, in the form shown, tank 40 includes an accessory depression 50 integrally extending from the top to a lower extent. Specifically, depression 50 includes a side face of a generally cylindrical configuration and which terminates in a bottom face and is of a size and shape to slideably receive accessories which would be useful in cleaning operations utilizing machine 10 according to the teachings of the present invention.

According to the preferred teachings of the present invention, machine 10 includes first and second hose reels 56 and 58. In the preferred form, each of the hose reels 56 and 58 include first and second circular discs 60 on opposite ends of an axial center spool. Discs 60 each have a circular outer periphery of a diameter and in the preferred form are equal in reels 56 and 58. In the most preferred form, discs 60 of hose reel 56 have a larger axial spacing than discs 60 of reel 58. In the most preferred form, reel 56 is utilized to hold a vacuum hose 62 while reel 58 is utilized to hold a solution hose 64, with hoses 62 and 64 allowing fluid passage therethrough and being windable on the center spools of reels 56 and 58 between discs 60.

In the most preferred form, hose reels 56 and 58 are mounted to and removable from machine 10 without the use of tools and in the most preferred form without utilizing a center shaft extending through the axial center spools of reels 56 and 58. In the preferred form, tank 40 includes a depression 70 formed in the top, with depression 70 being sized and shaped to slideably receive hose reels 56 and 58 in an operating position and in the most preferred form to receive discs 60 by movement of hose reels 56 and 58 in a radial direction to the center spool of hose reels 56 and 58 into the operating position. In the most preferred form, depression 70 has J-shaped cross sections and includes a generally semicylindrical portion 72 having a diameter generally equal to but slightly larger than the diameter of discs 60. An extension wall 74 extends generally tangentially from the back edge of semicylindrical portion 72 to a height above the back edge generally equal to a radius of discs 60. In the most preferred form, first, second and third lips 76 extend radially at and intermediate the opposite axial ends of semicylindrical portion 72. In the most preferred form, the axial spacing between the axially outer lips 76 is generally equal to but slightly longer than the combined axial length of reels 56 and 58 and of the intermediate lip 76. Lips 76 have a minimum size which is smaller than the generally semicylindrical portion 72.

It can be appreciated that hose reels 56 and 58 slideably received inside of depression 70 are rotatably mounted for rotation about the center spool by engaging the outer peripheries of discs 60 with semicylindrical portion 72 in the preferred form. In the most preferred form, suitable provisions such as TEFLON strips can be provided on the circular outer peripheries of discs 60 and/or semicylindrical portion 72 to reduce rotational friction therebetween. Lips 76 abut with one or both discs 60 when hose reels 56 and 58 are slideably received in depression 70 and on opposite axial sides of reels 56 and 58 to limit axial movement of hose reels 56 and 58 especially when hose reels 56 and 58 rotate within depression 70 such as to wind or unwind hoses 62 and 64 thereon. It can be appreciated that hose reels 56 and 58 slideably received in depression 70 could be rotatably mounted by center spool extensions on opposite axial sides of hose reels 56 and 58 which engage semicircular seats formed in lips 76. However, the manner of rotational mounting of the preferred form shown allows the axial length of hose reels 56 and 58 to be minimized while maximizing the holding space for hoses 62 and 64.

In the most preferred form, hose 62 includes a connection 80 directly into the hollow interior of tank 40 through extension wall 74 and while hose 62 is wound on reel 56 slideably received in depression 70. In the most preferred form, connection 80 allows rotation of hose 62 relative to extension wall 74. Thus, hose 62 can be wound on reel 56 when utilized to suction water and debris from the surface to be cleaned.

In the most preferred form, hose 64 includes a connection 82 in fluid connection with a fluid pump in the hollow interior of enlarged portion 20 and while hose 64 is wound on reel 58 slideably received in depression 70. Connection 82 allows reel 58 to be rotated in depression 70 such that hose 64 can be wound on reel 58 when utilized to deliver solution to the surface to be cleaned.

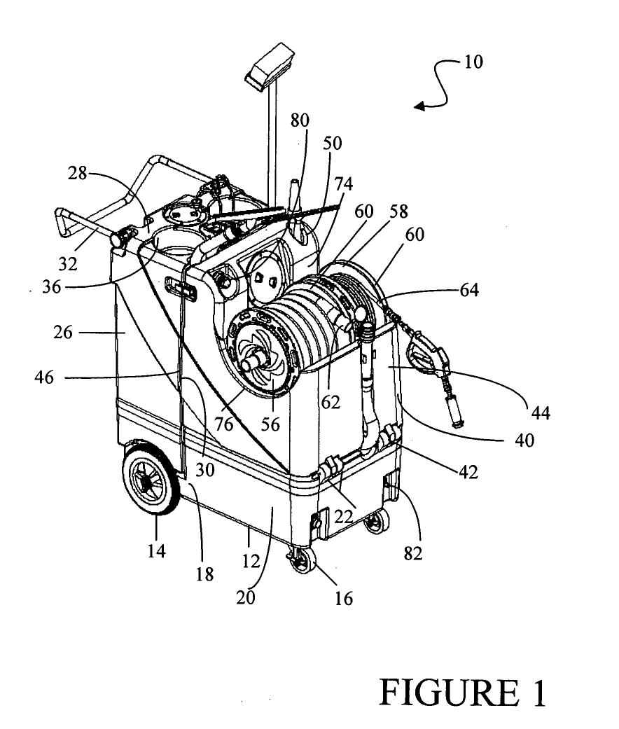

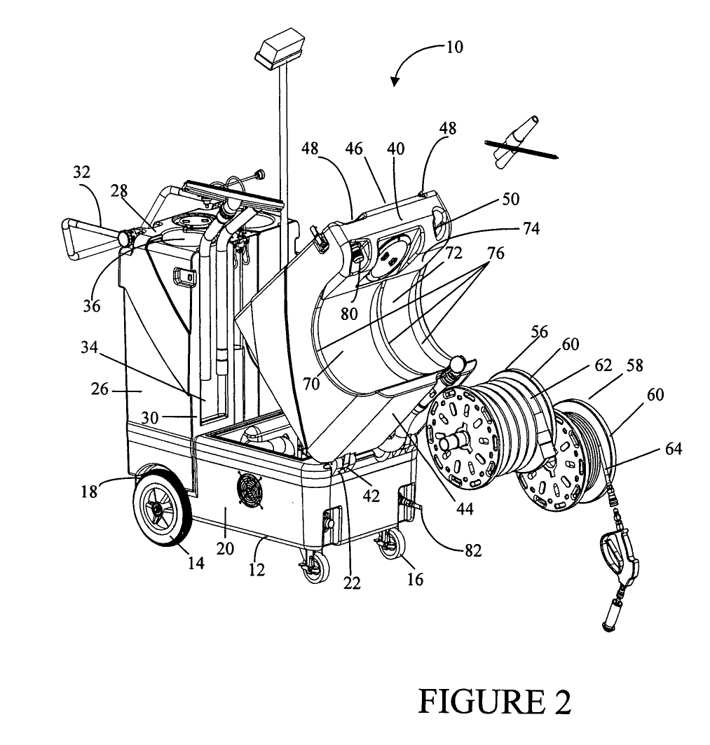

If and when access is needed to the hollow interior of enlarged portion 20 such as but not limited to servicing of mechanical components located therein, connections 80 and 82 can be removed from tank 40 and enlarged portion 20. After removal of connections 80 and 82, reels 56 and 58 can be simply lifted from depression 70 by movement in a radial direction to the center spools of hose reels 56 and 58. It can be appreciated that it is not necessary to unwind hoses 62 and 64 from reels 56 and 58 and, in fact, it would be desirable to have hoses 62 and 64 completely wound on reels 56 and 58 when they are removed from depression 70 for ease of handling and reduction in size. After reels 56 and 58 are removed, tank 40 can be pivoted from its transport position shown in FIG. 1 to its access position shown in FIG. 2. In its access position, the bottom of tank 40 is at least partially spaced from the open top of enlarged portion 20 and back 46 is at least partially spaced from front 30 of tank 26. When access is no longer needed, this procedure can be reversed to place tank 40 in its transport position.

In the transport position, the bottom of tank 40 engages and closes the open top of enlarged portion 20, and back 46 of tank 40 engages front 30 of tank 26. With back 46 and front 30 engaged, tool troughs 34 and tool channels 48 are aligned. Tool troughs 34 and tool channels 48 are of a corresponding shape and size and in the most preferred form are mirror images. When aligned, tool troughs 34 and tool channels 48 are adapted to slideably receive tools or accessories for support on the bottom faces thereof. Thus, tool troughs 34 and tool channels 48 store such tools or accessories spaced from the exterior surface of machine 10, in a tidy and organized manner and in a manner not prone to falling from machine 10. Furthermore, integrally forming tool troughs 34 and tool channels 48 increase the structural integrity of tanks 26 and 40. It should be appreciated that one or the other of tool troughs 34 and tool channels 48 could be eliminated and performed by the other. Likewise, tool troughs 34 and channel 48 could have other types and forms than shown, could be formed of differing sizes and shapes, or could be otherwise modified according to the teachings of the present invention.

In like manner, accessory depression 50 stores other tools or cleaning accessories on the body of machine 10. Furthermore, bottle depressions 36 are able to hold cylindrical solution containers of either circular, square, or rectangular cross section and in a manner which is tidy and aesthetically pleasing and in a manner which does not move relative to or fall from the body of machine 10. It can be appreciated that suitable provisions for automatically drawing solution from such containers for mixing with solution in tank 26 as it is being applied can be provided as desired.

Now that the basic teachings of the present invention have been explained, many extensions and variations will be obvious to one having ordinary skill in the art. For example, although machine 10 in the most preferred form includes several unique features and is believed to produce synergistic results, an all purpose cleaning machine could be constructed according to the teachings of the present invention utilizing such features individually or in other combinations. As an example, an all purpose cleaning machine 10 could be constructed utilizing removably mounted hose reels 56 and 58 and which does not include tool channels 48 and tool troughs 34 or vice versa.

Although shown as being received in a radial direction, hose reel 56 and/or 58 could be received in an axial direction such as in the back of tank 26 according to the teachings of the present invention. However, suitable provisions may be necessary to prevent such a hose reel from moving out of the depression since gravitational forces may not be sufficient as in depression 70 and such provisions may require manual manipulation which is also not required for depression 70 of the preferred form shown.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. Apparatus for cleaning comprising, in combination: a hose for fluid passage; a hose reel including at least a first disc on a center spool, with the hose being windable on the center spool; a tank; and a depression formed in the tank, with the depression being sized and shaped to slideably receive the at least first disc of the hose reel and to rotatably mount the hose reel slideably received inside of the depression for rotation about the center spool.

2. The cleaning apparatus of claim 1 with the at least first disc having a circular outer periphery, with the depression being sized and shaped to rotatably mount the hose reel by engaging the outer periphery of the at least first disc.

3. The cleaning apparatus of claim 2 with the depression being sized and shaped to receive the hose reel by movement of the hose reel in a radial direction to the center spool of the hose reel.

4. The cleaning apparatus of claim 3 with the depression including first and second radially extending lips having a size smaller than the depression, with the first and second lips abutting with the at least first disc when the hose reel is slideably received in the depression and on opposite axial sides of the hose reel.

5. The cleaning apparatus of claim 4 with the hose reel including a second disc having a circular outer periphery, with the first and second discs being on opposite ends of the center spool, with the hose being windable on the center spool between the first and second discs, with each circular outer periphery having a diameter, with the diameter of the circular outer peripheries of the first and second discs being equal, with the depression including a semicylindrical portion having a diameter equal to but slightly larger than the diameter of the circular outer peripheries of the first and second discs.

6. The cleaning apparatus of claim 5 with the depression being generally J-shaped, with the semicylindrical portion having a back edge, with the depression further having an extension wall extending generally tangentially from the back edge of the semicylindrical portion, with the extension wall extending from the back edge to an extent at least equal to one-half of the diameters of the outer circular peripheries.

7. The cleaning apparatus of claim 6 further comprising, in combination: a connection to the hose, with the tank having a hollow interior, with the connection being directly into the hollow interior of the tank through the extension wall and while the hose is wound on the hose reel slideably received in the depression.

8. The cleaning apparatus of claim 1 with the depression being sized and shaped to receive the hose reel by movement of the hose reel in a radial direction to the center spool of the hose reel.

9. The cleaning apparatus of claim 1 with the depression including first and second radially extending lips having a size smaller than the depression, with the first and second lips abutting with the at least first disc when the hose reel is slideably received in the depression and on opposite axial sides of the hose reel.

10. The cleaning apparatus of claim 1 further comprising, in combination: a support structure movably supported upon a surface, with the support structure being generally L-shaped and including a horizontal portion and a vertical portion, with the horizontal portion including a top, with the vertical portion including a front intersecting with the top, with the tank having a bottom and a back, with the tank being moveable relative to the support structure between a transport position and an access position, with the bottom engaging the top and the back engaging the front in the transport position, with the bottom being at least partially spaced from the top and the back being at least partially spaced from the front in the access position; and a tool channel integrally formed in at least one of the back of the tank and the front of the vertical portion, with the tool channel including a back face, side faces extending from the back face, and a bottom face extending between the back face and the side faces, with the tool channel adapted to slideably receive tools for support on the bottom face when the tank is in the transport position.

11. Apparatus for cleaning comprising, in combination: a support structure movably supported upon a surface, with the support structure being generally L-shaped and including a horizontal portion and a vertical portion, with the horizontal portion including a top, with the vertical portion including a front intersecting with the top; a tank having a bottom and a back, with the tank being moveable relative to the support structure between a transport position and an access position, with the bottom engaging the top and the back engaging the front in the transport position, with the bottom being at least partially spaced from the top and the back being at least partially spaced from the front in the access position; and a tool channel integrally formed in at least one of the back of the tank and the front of the vertical portion, with the tool channel including a back face, side faces extending from the back face, and a bottom face extending between the back face and the side faces, with the tool channel adapted to slideably receive tools for support on the bottom face when the tank is in the transport position.

12. The cleaning apparatus of claim 11 with the vertical portion of the support structure including another tank having the front, with the tool channel integrally formed in the back; and with the cleaning apparatus further comprising, in combination: a tool trough integrally formed in the front, with the tool trough being of a size and shape corresponding to the tool channel and aligned with the tool channel when the tank is in the transport position, with the tool channel aligned with the tool trough adapted to slideably receive tools for support on the bottom face when the tank is in the transport position.

13. The cleaning apparatus of claim 12 with the other tank including a top panel, with the top panel including an integral bottle depression having a generally cylindrical sheet terminating in a bottom sheet, with the integral bottle depression adapted to slideably receive a bottle for support on the bottom sheet.

14. The cleaning apparatus of claim 12 with the support structure further including a base assembly having a tipped h-shape, with the base assembly including a projecting portion extending from an enlarged portion, with the enlarged portion including the top, with the top being open, with the other tank engaging and supported upon the projecting portion, with the base assembly being moveably supported upon the surface.

15. The cleaning apparatus of claim 11 with the tank including a top, and with the cleaning apparatus further comprising in combination: an accessory depression integrally formed in the top, with the accessory depression including a generally cylindrical sheet terminating in a bottom sheet, with the accessory depression adapted to slideably receive an accessory for support on the bottom sheet.

16. Apparatus for cleaning comprising, in combination: a hose for fluid passage; a hose reel including at least a first disc on a center spool, with the hose being windable on the center spool; a body movably supported on a surface; and a depression formed in the body, with the depression being sized and shaped to slideably receive the hose reel by movement of the hose reel in a radial direction to the center spool of the hose reel and to rotatably mount the hose reel slideably received inside of the depression for rotation about the center spool.

17. The cleaning apparatus of claim 16 with the depression including first and second radially extending lips having a size smaller than the depression, with the first and second lips abutting with the at least first disc when the hose reel is slideably received in the depression and on opposite axial sides of the hose reel.

18. The cleaning apparatus of claim 17 with the hose reel including a second disc, with the first and second discs being on opposite ends of the center spool, with the hose being windable on the center spool between the first and second discs, with the first and second discs each having a circular outer periphery, with the depression being sized and shaped to rotatably mount the hose reel by engaging the outer peripheries of the first and second discs.

19. The cleaning apparatus of claim 18 with each circular outer periphery having a diameter, with the diameter of the circular outer peripheries of the first and second discs being equal, with the depression having a semicylindrical portion being a diameter equal to but slightly larger than the diameter of the circular outer peripheries of the first and second discs.

20. The cleaning apparatus of claim 16 further comprising, in combination: a handle attached to the body for grasping to maneuver the body upon the surface.
